(19) United States
(12) Patent Application Publication
(10) Pub. No.: US 2021/0352424 A1
(43) Pub. Date: Nov. 11, 2021

(54) Confirming Accessory Functionality

(71) Applicant: Apple Inc., Cupertino, CA (US)

(72) Inventors: Jonathan M. VanKeulen, San Jose, CA (US); Sunil K. Singh, San Jose, CA (US)

(21) Appl. No.: 16/870,285

(22) Filed: May 8, 2020

(51) Int. Cl. H04R 29/00; G06F 11/36; G06F 11/273

(52) U.S. Cl. CPC H04R 29/004; H04R 29/008; G06F 11/2733; G06F 11/3688; G06F 11/3692

(57) ABSTRACT

A method of confirming an accessory functionality of an accessory device includes obtaining an accessory device description that includes information regarding the accessory device and identifying a test case based on the accessory device description. The test case is configured to evaluate the accessory functionality and includes a test standard. The method also includes performing, by a test device, a test procedure that corresponds to the test case. The test procedure causes the accessory device to perform an action that corresponds to the accessory functionality. The method also includes recording an observation regarding the action, and determining whether a test result corresponds to a pass condition or a fail condition based on a comparison of the observation to the test standard.

### TECHNICAL FIELD

This disclosure relates to testing hardware devices.

### BACKGROUND

Devices can be designed to comply with one or more standards that describe how the device should function. Testing devices to ensure compliance with the standards can be time consuming.

### SUMMARY

One aspect of the disclosure is a method of confirming an accessory functionality of an accessory device. The method includes obtaining an accessory device description that includes information regarding the accessory device and identifying a test case based on the accessory device description. The test case is configured to evaluate the accessory functionality and includes a test standard. The method also includes performing, by a test device, a test procedure that corresponds to the test case. The test procedure causes the accessory device to perform an action that corresponds to the accessory functionality. The method also includes recording an observation regarding the action, and determining whether a test result corresponds to a pass condition or a fail condition based on a comparison of the observation to the test standard.

The information regarding the accessory device may identify the accessory functionality. The information regarding the accessory device may identify a feature of the accessory device, where the feature is associated with the accessory functionality.

In some implementations, performing the test procedure includes transmitting, from the test device to the accessory device, a command that causes the accessory device to perform the action.

In some implementations, the test device records the observation regarding the action in response to manual entry of information corresponding to the observation.

In some implementations, the test procedure is an audio-based test procedure, recording the observation regarding the action includes obtaining an audio recording for the audio-based test procedure using a microphone that is associated with the test device, and determining whether the test result corresponds to the pass condition or the fail condition includes analyzing the audio recording to identify an audio feature and comparing the audio feature to an expected audio feature that is described by the test standard.

In some implementations, the test procedure is an image-based test procedure, recording the observation regarding the action includes obtaining an image for the image-based test procedure using a camera that is associated with the test device, and determining whether the test result corresponds to the pass condition or the fail condition includes analyzing the image to identify an image feature and comparing the image feature to an expected audio feature that is described by the test standard.

In some implementations, the test procedure is a three-dimensional feature based test procedure, recording the observation regarding the action includes a three-dimensional scene representation using a three-dimensional sensor that is associated with the test device, and determining whether the test result corresponds to the pass condition or the fail condition includes analyzing the image to identify three-dimensional feature and comparing the three-dimensional feature to an expected three-dimensional feature that is described by the test standard.

Another aspect of the disclosure is a method of confirming an accessory functionality of an accessory device. The method includes receiving, by a test device from a testing server, a test case that is identified by the testing server based on the accessory functionality. The test case is configured to evaluate the accessory functionality and includes a test standard. The method also includes performing, by the test device, a test procedure that corresponds to the test case. The test procedure causes the accessory device to perform an action that corresponds to the accessory functionality. The method also includes recording an observation regarding the action, and determining whether a test result corresponds to a pass condition or a fail condition based on a comparison of the observation to the test standard.

In some implementations, performing the test procedure includes transmitting, from the test device to the accessory device, a command that causes the accessory device to perform the action.

In some implementations, the test device records the observation regarding the action in response to manual entry of information corresponding to the observation.

In some implementations, the test procedure is an audio-based test procedure, recording the observation regarding the action includes obtaining an audio recording for the audio-based test procedure using a microphone that is associated with the test device, and determining whether the test result corresponds to the pass condition or the fail condition includes analyzing the audio recording to identify an audio feature and comparing the audio feature to an expected audio feature that is described by the test standard.

In some implementations, the test procedure is an image-based test procedure, recording the observation regarding the action includes obtaining an image for the image-based test procedure using a camera that is associated with the test device, and determining whether the test result corresponds to the pass condition or the fail condition includes analyzing the image to identify an image feature and comparing the image feature to an expected audio feature that is described by the test standard.

In some implementations, the test procedure is a three-dimensional feature based test procedure, recording the observation regarding the action includes a three-dimensional scene representation using a three-dimensional sensor that is associated with the test device, and determining whether the test result corresponds to the pass condition or the fail condition includes analyzing the image to identify three-dimensional feature and comparing the three-dimensional feature to an expected three-dimensional feature that is described by the test standard.

Another aspect of the disclosure is a non-transitory computer-readable storage device including program instructions executable by one or more processors that, when executed, cause the one or more processors to perform operations. The operations include receiving, by a test device from a testing server, a test case that is identified by the testing server based on an accessory functionality of an accessory device. The test case is configured to evaluate the accessory functionality and includes a test standard. The operations also include performing, by the test device, a test procedure that corresponds to the test case, wherein the test procedure causes the accessory device to perform an action that corresponds to the accessory functionality. The operations also include recording an observation regarding the action. The operations also include determining whether a test result corresponds to a pass condition or a fail condition based on a comparison of the observation to the test standard.

In some implementations, performing the test procedure includes transmitting, from the test device to the accessory device, a command that causes the accessory device to perform the action.

In some implementations, the test device records the observation regarding the action in response to manual entry of information corresponding to the observation.

In some implementations, the test procedure is an audio-based test procedure, recording the observation regarding the action includes obtaining an audio recording for the audio-based test procedure using a microphone that is associated with the test device, and determining whether the test result corresponds to the pass condition or the fail condition includes analyzing the audio recording to identify an audio feature and comparing the audio feature to an expected audio feature that is described by the test standard.

In some implementations, the test procedure is an image-based test procedure, recording the observation regarding the action includes obtaining an image for the image-based test procedure using a camera that is associated with the test device, and determining whether the test result corresponds to the pass condition or the fail condition includes analyzing the image to identify an image feature and comparing the image feature to an expected audio feature that is described by the test standard.

In some implementations, the test procedure is a three-dimensional feature based test procedure, recording the observation regarding the action includes a three-dimensional scene representation using a three-dimensional sensor that is associated with the test device, and determining whether the test result corresponds to the pass condition or the fail condition includes analyzing the image to identify three-dimensional feature and comparing the three-dimensional feature to an expected three-dimensional feature that is described by the test standard.

Another aspect of the disclosure is a system that includes a memory and one or more processors that are configured to execute instructions that are stored in the memory. The instructions, when executed by the one or more processors, cause the one or more processors to receive, from a testing server, a test case that is identified by the testing server based on an accessory functionality of an accessory device, wherein the test case is configured to evaluate the accessory functionality and includes a test standard. The instructions further cause the one or more processors to perform a test procedure that corresponds to the test case, wherein the test procedure causes the accessory device to perform an action that corresponds to the accessory functionality. The instructions further cause the one or more processors to record an observation regarding the action. The instructions further cause the one or more processors to determine whether a test result corresponds to a pass condition or a fail condition based on a comparison of the observation to the test standard.

In some implementations performing the test procedure includes transmitting, to the accessory device, a command that causes the accessory device to perform the action.

In some implementations, the instructions further cause the one or more processors to record the observation regarding the action in response to manual entry of information corresponding to the observation.

In some implementations, the test procedure is an audio-based test procedure, the instructions further cause the one or more processors to record the observation regarding the action by obtaining an audio recording for the audio-based test procedure using a microphone, and determining whether the test result corresponds to the pass condition or the fail condition includes analyzing the audio recording to identify an audio feature and comparing the audio feature to an expected audio feature that is described by the test standard.

In some implementations, the test procedure is an image-based test procedure, recording the observation regarding the action includes obtaining an image for the image-based test procedure using a camera, and determining whether the test result corresponds to the pass condition or the fail condition includes analyzing the image to identify an image feature and comparing the image feature to an expected audio feature that is described by the test standard.

In some implementations, the test procedure is a three-dimensional feature based test procedure, recording the observation regarding the action includes a three-dimensional scene representation using a three-dimensional sensor that is associated with the test device, and determining whether the test result corresponds to the pass condition or the fail condition includes analyzing the image to identify three-dimensional feature and comparing the three-dimensional feature to an expected three-dimensional feature that is described by the test standard.

### BRIEF DESCRIPTION OF THE DRAWINGS

FIG. 1 is a block diagram that shows a system for controlling accessory devices.

FIG. 2 is a block diagram that shows a system for confirming accessory functionality.

FIG. 3 is a flowchart that shows an example of a process for confirming accessory functionality.

FIG. 4 is a flowchart that shows an example of a process for performing a test procedure.

FIG. 5 is an illustration that shows an example of a hardware configuration for a computing device.

### DETAILED DESCRIPTION

The systems and methods that are described herein relate to accessory devices that perform an accessory functionality. Confirming proper operation of the accessory functionality is performed by a test device under direction from a remotely-located testing server. The testing server maintains testing standards and test cases, which may be updated from time to time. The testing server is able to determine a test plan for an accessory device based on a description of the features and/or types of accessory functionality that are included in the accessory device. The test plan is transmitted to the test device by the testing server where test procedures are performed to evaluate the accessory functionality of the accessory device. The test procedures are performed using a testing application to automate some or all of the activities that are included in the test procedures. If the test standard is updated or if the test cases are updated after the test plan is initially determined, the test plan may be updated by the testing server and the updated test plan is transmitted to the test device by the testing server.

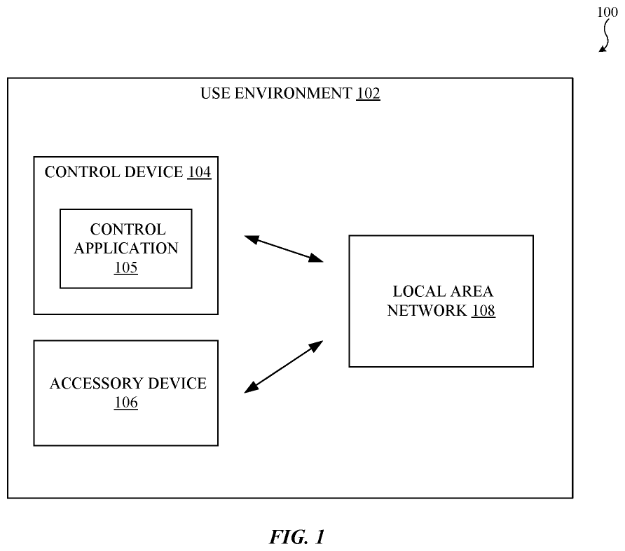

FIG. 1 is a block diagram that shows a system 100 for controlling accessory devices. The system 100 includes a use environment 102. The use environment 102 is a location where controlling accessory device occurs. In typical use cases, the use environment 102 may be a private home or a business. In the illustrated implementation, the use environment 102 includes a control device 104, a control application 105, an accessory device 106, and a local area network 108. As will be explained herein, the accessory device 106 is configured to perform a function that is referred to herein as an accessory functionality.

The control device 104 is a device that a user (e.g., a person) uses to control an accessory functionality of the accessory device 106. The control device 104 may be, as examples, a desktop computer, a laptop computer, a tablet computer, or a smart phone. The control device 104 includes conventional computing components that allow for storage and execution of computer program instructions. As an example, the control device 104 may include a processor, a memory, and a storage device.

The control device 104 includes communications components that allow the control device 104 to send and receive information using the local area network 108. As an example, the control device 104 may be configured to send information to the accessory device 106 and to receive information from the accessory device 106.

The control device 104 is configured to execute the control application 105. The control application 105 is a software application (e.g., computer-interpretable program instructions) that allow the control device to control aspects of the configuration and operation of the accessory device 106. The control device 104 may further be configured to control operation of multiple devices using the control application 105. As an example, the control application 105 may include a user interface that allows a user of the control device 104 to identify devices in the use environment 102 that can be controlled by the control device 104, and configure those devices for use with the control device 104. The user interface of the control application 105 may display information that identifies and/or describes the devices that can be controlled by the control device 104. The user interface of the control application 105 may identify and/or describe actions that can be taken with respect to each of the devices, such as inspecting states of the devices, viewing sensor outputs of the devices, changing states of the devices, and/or sending commands to the devices that cause the devices to perform an action, such as the actions described with respect to the accessory functionality of the accessory device 106.

The control device 104 may communicate with the accessory device 106 to send commands to the accessory device 106 to control the accessory functionality. The control device 104 may communicate with the accessory device 106 to receive information from the accessory device 106. As one example, information received from the accessory device 106 may describe a current state of the accessory device and/or a current state of one or more types of accessory functionality that are implemented by the accessory device 106.

The accessory device 106 is a device that incorporates computing functionality, incorporates communications functionality, and is able to implement one or more types of accessory functionality. The accessory device 106 is located in the use environment 102 and is able to communicate with the control device 104. The accessory device 106 may be configured to communicate with the control device 104 using communications connection that is established using the local area network 108. The accessory device 106 may be configured to communicate with the control device 104 using communications connection that is established directly between the accessory device 106 and the control device 104 (e.g., without relay, routing, or other involvement of other devices including networking devices that are not included in the accessory device 106 and the control device 104).

The computing functionality that is included in the accessory device 106 is sufficient to allow the accessory device to receive information and commands, and take actions in response to the information and commands. As examples, the accessory device 106 may include computing functionality sufficient to allow the accessory device 106 to receive a command, interpret the command, perform a function in response to the command, and send response messages to the accessory device 106. The accessory device 106 may include, as examples, a processor, a memory, and a storage device. The accessory device 106 may be able to, for example, load computer program instructions from the data storage device into the memory, and execute the computer program instructions using the processor.

The accessory device 106 is able to communicate with other devices, for example, using wired or wireless networking technologies. In the illustrated implementation, the accessory device 106 is able to send and receive information using the local area network 108. For example, the accessory device 106 may receive commands from the control device 104 over the local area network 108 and the accessory device 106 may send response messages to the control device 104 over the local area network 108. The accessory device 106 may also be configured to send and receive information directly to and from the control device 104. As an example, a direct communications connection may be established (e.g., by pairing) using a suitable short range device-to-device communications protocol. Direct communications may be used, for example, to initially configure the accessory device 106, including configuring the accessory device 106 to access the local area network 108.

An accessory functionality is a specific function that is performed by the accessory device 106. As examples, the accessory functionality may be an action performed by the accessory device 106, a result caused by operation of the accessory device 106, or an output that is generated by the accessory device 106. When an accessory functionality is performed by the accessory device 106, the result of performing the accessory functionality can be confirmed. Confirming the result of performing the accessory functionality may include, as examples, observing the result of performing the accessory functionality, sensing the result of performing the accessory functionality, and/or measuring the result of performing the accessory functionality. In some implementations, the result of performing the accessory functionality can be visually observed, such as illumination or motion caused by the accessory device 106. In some implementations, the results of performing an accessory functionality can be audibly observed, such as a sound emitted by the accessory device. In some implementations, the results of performing an accessory functionality can be measured using a device or tool, such as an output value or command transmitted by a wired or wireless computing network such as the local area network 108.

Examples of accessory functionality that the accessory device 106 may be configured to perform include powering on, powering off, connecting to a communications network such as the local area network 108, changing an illumination state of an indicator light (e.g., by illuminating, by changing to a color, or by blinking) to indicate an operating condition of the device, outputting an audible indication (e.g., by beeping) to indicate an operating condition of the device, changing an illumination state (e.g., on or off) of a lighting device (e.g., a task lighting device or a room-level lighting device), changing an illumination intensity of a lighting device, changing an illumination color of a lighting device, changing a state of a mechanical door lock between a locked state and an unlocked state, changing a position of a movable element (e.g., a motorized window covering), and other types of functionalities.

The accessory functionality of the accessory device 106 may be implemented using computer-executable program instructions that executed by the accessory device 106. As an example, the accessory device 106 may receive a command from the control device 104 over the local area network 108, interpret the command using the computer-executable program instructions, and perform an action according to the command.

In some implementations, the use environment 102 is a home, office, business, or other place where one or more “smart devices” are in use. The one or more smart devices are represented by the accessory device 106. The one or more smart devices are devices that incorporate computing functionality and communications functionality. Examples of smart devices include smart home devices and home automations devices. The smart devices that are represented by the accessory device 106 include devices for which computing functionality and/or communications functionality may not be strictly necessary, and which are intended to perform a function that is not typically included in a conventional computing device, such as causing an action to occur in the use environment 102 and/or monitoring an environmental condition in the use environment 102. Examples of devices that may be included as the smart devices that are represented by the accessory device 106 include a camera, a doorbell, a garage door opener, a lighting device, a door lock, a power outlet, a security system component, a smart speaker, an electrical switch, motorized window coverings, and a vehicle (inclusive of specific individual vehicle systems such as lighting systems, entertainment systems, and navigation systems). These are examples, and the accessory device 106 may be other types of devices.

Various conditions or other mechanisms may be used to cause the accessory device 106 to perform the accessory functionality. As one example, the accessory functionality may be performed continuously while the accessory device 106 is active (e.g., in an operating state as opposed to a non-operating state). As another example, the accessory functionality may be performed periodically (e.g., once per time interval including fixed time intervals and variable time intervals) while the accessory device 106 is active. As another example, the accessory functionality may be performed by the accessory device 106 in response to a command that is received by the accessory device 106 from the control device 104 or from another source. As another example, the accessory functionality may be performed by the accessory device 106 in response to operation of a physical input device that is associated with the accessory device 106. As another example, the accessory functionality may be performed by the accessory device 106 in response to a condition (e.g., an environmental condition in the use environment 102) that is sensed by the accessory device 106, for example, using a sensor that is included in the accessory device 106.

The local area network 108 is a data communications network by which computing devices can transmit information to each other using appropriate interfaces and according to established communications protocols. The local area network 108 may be a wired network or a wireless network that is implemented using now known or later developed network communications standards and protocols.

In operation, the control application 105 is executed by the control device 104 to allow the control device 104 to exercise control over the accessory device 106. The control device 104 establishes a communications connection with the accessory device (e.g., “pairing”) using the local area network 108. Using the control software, the control device 104 is configured to send commands to the accessory device 106. The accessory device 106 is configured to perform actions according to one or more types of accessory functionality that are included in the accessory device 106, either in response to the commands, according to instructions included in the accessory device 106, or in response to another circumstance or condition. Upon receiving the command from the control device 104, the accessory device performs one or more actions in accordance with the accessory functionality. The control device 104 may also, in response to commands from the control device 104 or without receiving a command from the control device 104, send information to the control device 104, such as information regarding a current status of the accessory device 106 or information derived from sensors that are associated with the accessory device 106.

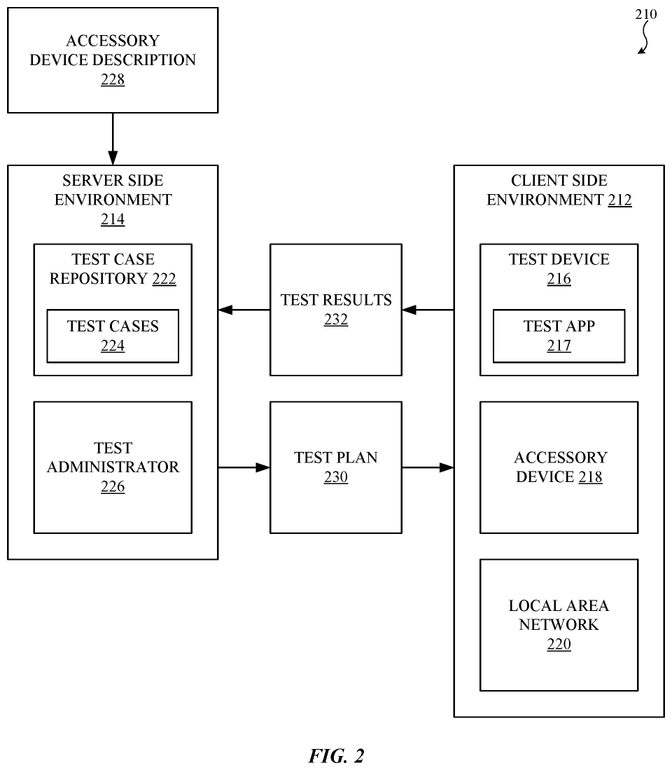

FIG. 2 is a block diagram that shows a system 210 for confirming accessory functionality. The system 210 includes a test environment 212 and a testing server 214. The test environment 212 is a location where a test to confirm accessory functionality is performed. The test environment 212 is described herein as a single instance of testing, but it representative of multiple (e.g., thousands) of similar locations where testing is occurring under supervision by the testing server 214. The testing server 214 is a computing device or system (e.g., multiple computing devices) that controls aspects of the test from a remote location from which aspects of the test are controlled. As will be explained further herein, the testing server 214 maintains information describing individual tests, determines which tests will be performed at the test environment in a particular testing scenario, and receives and stores the results of those tests.

The test environment 212 is a location where tests are performed. The test environment 212 may be located at a remote location relative to the testing server 214. The test environment 212 is an example that represents numerous similar environments were testing is performed in cooperation with the testing server 214. In the illustrated implementation, the test environment 212 includes a test device 216, a testing application 217, an accessory device 218, and a local area network 220.

The test device 216 is a computing device that is used to execute a test procedure that is performed within the test environment. The test device 216 may be, as examples, a desktop computer, a laptop computer, a tablet computer, or a smart phone. The test device 216 includes conventional computing components that allow for storage and execution of computer program instructions. As an example, the test device 216 may include a processor, a memory, and a storage device.

The test device 216 includes communications components that allow the test device to send and receive information using the local area network 220. As an example, the test device may be configured to send information to the accessory device 218 and to receive information from the accessory device 218.

The test device 216 may include input components. As one example, the input components may include a microphone that is able to perceive sound in the test environment 212 and generate an output signal that represents the sound. As another example, the input components may include a light sensor that is able to measure an ambient light level in the test environment 212 and generate an output signal that represents the ambient light level. As another example, the input components may include a thermometer that is able to measure an ambient temperature level in the test environment 212 and generate an output signal that represents the ambient temperature level. As another example, the test device 216 may include a still image camera or a video camera that is able to obtain images in the test environment 212 (e.g., video image frames comprised of pixels or still image frames comprised of pixels). As another example, the test device 216 may include a three-dimensional sensor that is operable to obtain data representing the positions and orientations of surfaces in an environment. This data may be referred to herein as a three-dimensional scene representation. The three-dimensional scene representation obtained by the three-dimensional sensor may be, for example, a point cloud, and may be interpreted into other forms for further processing, such as a voxel-based representation or a three-dimensional mesh. One example of a three-dimensional sensor is a Lidar device. Another example of a three-dimensional sensor is a depth camera. Another example of a three-dimensional sensor is a structured light sensor.

The test device 216 is configured to execute a testing application 217. The testing application 217 is a software application that may be stored locally or may be stored so that it is accessible to the test device 216 and can be executed by the test device 216. As an example, the testing application 217 may be stored by a storage device that is included in the test device 216, loaded into a memory of the test device 216, and executed by a processor of the test device 216.

The testing application 217 may allow a user to control certain testing activities. As examples, the testing application 217 may allow the user to start testing, stop testing, pause testing, input information regarding a test (e.g., manual entry of test results), select a specific test to be performed, and/or perform other operations that relate to testing of the accessory device 218.

The accessory device 218 is the device that is being tested by the test device 216 in the test environment 212. The accessory device 218 incorporates computing functionality, incorporates communications functionality, and is able to implement one or more types of accessory functionality, as previously described with respect to the accessory device 106. The accessory device 218 is equivalent to the accessory device 106. The description of the accessory device 106 is applicable to the accessory device 218 and is incorporated in the description of the accessory device 218.

The accessory device 218 is able to communicate with other devices, for example, using wired or wireless networking technologies. In the illustrated implementation, the device is able to send and receive information using the local area network 220. The accessory device 218 may receive commands from the test device 216 over the local area network 220 and the accessory device 218 may send response messages to the test device 216 over the local area network 220. The accessory device 218 may also be configured to communicate directly with the test device 216.

The local area network 220 is a communications network that allows electronic devices to send and receive information using established protocols. The local area network may be a wired network or a wireless network. The local area network 220 may be limited in terms of the area it serves, for example, permitting direct access only to devices that are located in and around the test environment 212. For example, the test device 216 and the accessory device 218 may both connect directly to the local area network 220 by wired or wireless connections to allow communications between the test device 216 and the accessory device 218. The local area network 220 may be connectable to other communications networks (e.g., the Internet), for example, to allow the test device 216 to communicate with the testing server 214.

The testing server 214 may be implemented using a single computing devices or many computing devices. The features of the testing server 214 may, therefore, be implemented by multiple different computing devices that handle different portions of the functionality described with respect to the testing server 214, and further, individual functions may be distributed across multiple different computing devices that operate in parallel or in series. In the illustrated implementation the testing server includes a test repository 222 and a test administrator 224. The test repository 222 and the test administrator 224 may each be implemented in the form of software and/or data storage structures (e.g., databases or other information storage structures).

The test repository 222 includes test cases 226. Each of the test cases 226 corresponds to a test that can be performed in a specific manner to evaluate a specific type of accessory functionality of the accessory device 218. For example, the test cases may judge whether or not a performance standard has been met, where the performance standard relates to a specific type of accessory functionality. The test cases 226 may each include information that describes the test that will be performed. The test cases 226 may each include information that describes a condition to be satisfied in order to judge whether the result of the test has been successfully completed (e.g., a pass result when the condition is satisfied and a fail result when the condition is not satisfied).

The test cases 226 may include computer-executable instructions that are configured to cause another system (e.g., the test device 216 using the testing application) to perform the test. For example, the test cases 226 may include instructions to cause the test device 216 to send one or more commands to the accessory device 218, one or more commands to cause the test device to obtain information (e.g., by sensors or by manual input) describing a result of sending the one or more commands to the accessory device 218 (e.g., state change of the accessory device 218, action performed by the accessory device 218, etc.), one or more commands to cause the test device 216 to compare the result to a condition to be satisfied to determine whether the result of the test corresponds to a pass condition or a fail condition, and/or one or more commands to cause the test device 216 to transmit results of the test to the testing server 214.

The test repository 222 allows the test cases 226 to be accessed by other systems. The test repository 222 may allow the test cases 226 to be identified according to information (e.g., metadata) that is associated with each of the test cases 226.

As one example, identification of test cases 226 may be performed using a unique identifier for each of the test searching function that is associated with the test repository 222.

As another example, identification of test cases 226 may be performed using a searching function that is associated with the test repository. A query may be submitted to the searching function, in response to the query, the searching function identifies any test cases 226 that are determined to be relate to the query (e.g., by matching of the query with metadata associated with the test cases), and the searching function outputs results.

Results output by the test repository 222 in response to a request from another system may include information in any form that relates to the test cases 226. As one example, results output by the test repository 222 may include information corresponding to the test cases 226 (e.g., one or more of the test cases 226 or portions thereof such as test procedures and/or other information) that is transmitted to the requesting system. The test repository 222 may output the results by transmitting, from the test repository 222 to the requesting system, a list of the test cases 226 that were determined to be related to a query.

The test administrator 224 coordinates testing of external accessory devices at many distributed locations, including control of testing of the accessory device 218 by the test device 216 using the control software. The test administrator 224 may be implemented in the form of computer interpretable program instructions (e.g., software) that is executed by one or more computing devices that are included in the testing server 214.

The functions performed by the test administrator 224 may include determining which tests will be performed to confirm the accessory functionality of the accessory device 218. The functions performed by the test administrator 224 may include transmitting information to the test device 216 that describes the tests to be performed and/or includes information (e.g., computer program instructions) that cause the test device 216 to perform specific test procedures using the testing application 217. The functions performed by the test administrator 224 may include receiving information from the test device 216 that describes results of tests performed on the accessory device 218 by the test device 216.

In the illustrated implementation, the testing server 214 receives an accessory device description 228 as in an input and generates a test plan 228 as an output. The accessory device description 228 is information that describes characteristics of the accessory device 218. The accessory device description 228 may include information that identifies specific types of accessory functionality that will be performed by the accessory device 218. As one example, the accessory device description 228 may be a list of types of accessory functionality that are included in the accessory device 218. As another example, the accessory device description may be a list of types of features included in the accessory device 218 where each of the features corresponds to either a single type of accessory functionality or to a list or two or more different types of accessory functionality. As another example, the accessory device description may include a list of hardware and software (e.g., operating system type and version) configurations for control devices that the accessory device is to be used with to ensure compatibility with such devices.

The accessory device description 228 is provided to the testing server 214 before testing of the accessory device 218 begins. The accessory device description 228 may be provided to the testing server 214 by the test device 216, or by another device (e.g., at a remote location with respect to the testing server 214. As one example, the accessory device description 228 may be in the form of information collected using a software application or form that allows a user to select features included in the accessory device 218, select types of accessory functionality included in the accessory device 218, answer questions regarding the accessory device 218, and/or otherwise provide information regarding the accessory device 218.

In one implementation, to determine the accessory device description 228, a software application guides a user through a series of questions regarding the accessory device 218. The questions are hierarchical and include questions that ask the user to indicate whether the accessory device 218 includes functionalities that belong to a category of functionalities (e.g., lighting device functionality, kitchen appliance functionality). For each category of functionality indicated as present in the accessory device 218 (according to the answers provided by the user), the software application presents further questions to the user, either regarding presence of specific types of accessory functionality or regarding presence of functionalities for subcategories of accessory functionality. Once the questions are answered, the information collected by the software application is output as the accessory device description 228.

The testing server 214 receives an accessory device description 228 as an input. The accessory device description 228 is processed by test administrator 224 of the testing server 214. The test administrator 224 uses the accessory device description 228 to generate a test plan 230 as an output. The test plan 230 includes a group of the test cases 226 and may also include other information. Some or all of the test cases 226 that are included in the test plan 230 are selected using the accessory device description 228. For example, the test administrator 224 may request from the test repository 222 all of the test cases 226 that match the types of features, categories of accessory functionality, and/or types of accessory functionality that are included in the accessory device 218. The test administrator 224 may also request some of the test cases 226 from the test repository 222 for reasons other than information included in the accessory device description 228. As an example, the test administrator 224 may request a standard set or group of the test cases 226 that are used for testing of all devices regardless of the features or specific types of accessory functionality that are included in the accessory device 218.

In response to the requests from the test administrator 224, the test repository 222 provides matching ones of the test cases 226 to the test administrator 224. The test administrator 224 incorporates the test cases 226 in the test plan 230. In addition to the test cases 226, the test plan 230 may include other information, such as a list of the test cases 226, metadata associated with the test cases 226 (e.g., version information for each of the test cases 226), and/or other information.

After the test plan 230 has been generated by the test administrator 224, the test administrator 224 sends the test plan 230 to the test device 216. The test plan 230 is processed by the testing application 217 which causes (e.g., either with manual assistance or without manual intervention) the test device 216 to conduct testing of the accessory device 218. As will be discussed further herein with respect to specific implementations, test device 216 uses the test plan 230 and the test cases 226 that are included in it to perform test procedures that evaluate accessory functionality of the accessory device 218. Upon completion of some or all of the tests described by the test cases 226 that are included in the test plan 230, the test device 216 transmits the test results 232 to the testing server 214 where they are processed by the test administrator 224. As examples, the test administrator 224 may store the test results 232, send notifications to one or more users regarding the test results 232, and/or perform other actions regarding the test results 232.

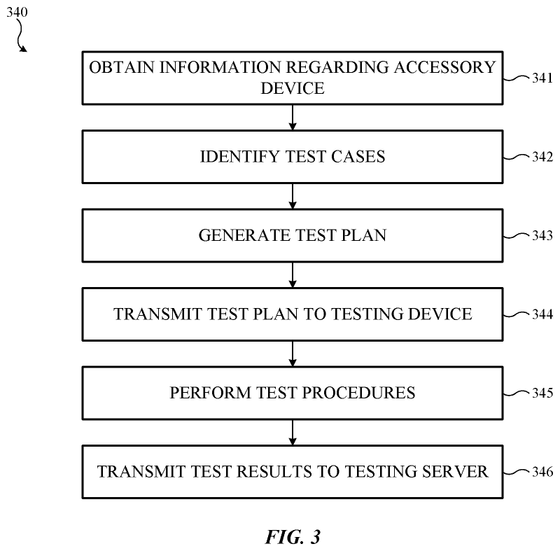

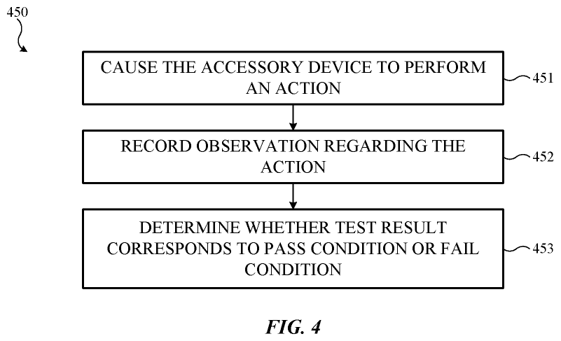

The system 210 may perform a number of processes in support of confirming accessory functionality of devices such as the accessory device 218. Examples of these processes will be described in detail with reference to FIGS. 3-4. These processes can be implemented using the system 210, and the description of the system 210 is applicable to the processes described herein.

The processes may be implemented using a computing device or using multiple computing devices. As one example, the processes described herein may be performed using a computing device that includes a processor, a memory, and computer-interpretable instructions that are stored in the memory and accessible to the processor, wherein the instructions, when executed by the processor, cause the processor to perform the operations of the process. In some implementations, the processes described herein are implemented in the form of a computer readable storage device that includes computer-interpretable program instructions that cause operation of the process when executed. It should be understood that any method, process, operation, step, etc., that is described as being performed by a single computing device can also be performed by multiple computing devices through parallel operations or serial operations.

FIG. 3 is a flowchart that shows an example of a process 340 for confirming accessory functionality. The process 340 may be implemented using components that are implemented according to the description of components of the system 210.

Operation 341 includes obtaining information regarding an accessory device (e.g., the accessory device 218). Operation 341 may be performed by a server system, such as the testing server 214.

Examples of obtaining information include accessing the information from a storage device, accessing the information from short-term memory, receiving a wired or wireless transmission that includes the information, receiving user inputs (e.g., signals from an input device that represent user inputs). As an example, the information may be input by a user in a software application and stored, transmitted or otherwise made available to the computing device that is performing the process 340.

The information regarding the accessory device may be information that identifies features that are included in the accessory device. The information regarding the accessory device may be or include information that identifies functions performed by the accessory device (e.g., functions that the accessory device is configured to perform). The information regarding the accessory device may be or include information that identifies a category of accessory functionality. The information regarding the accessory device may be or include information that describes a specific type of accessory functionality. The information regarding the accessory device may be encoded in a computer interpretable data format, for example, including data values in a format a format that indicates the meanings of the values (e.g., a data type identifier and a list of one or more data values that correspond to the data type identifier).

Operation 342 includes identifying test cases based on the information regarding the accessory device that was obtained in operation 341. As an example, the information regarding the accessory device may identify an accessory functionality and identifying the test cases based on the accessory device description may identify test cases that are configured to evaluate the accessory functionality that is identified by the information regarding the accessory device. Operation 342 may be performed by a server system, such as the testing server 214.

Some or all of the test cases may include computer interpretable instructions that control performance of a test procedure. Some or all of the test cases may include a test standard that is used to judge whether a result of the test procedure corresponds to a pass condition or a fail condition. As used here the term “test standard” refers to information that describes an acceptable result, an acceptable measured value, an acceptable range values, or other condition by which the result of a test can be judged that, if satisfied, indicates that the device under test has performed acceptably (e.g., is in compliance with the test standard).

Examples of identifying the test cases include use of searching functions, matching functions, lookup functions that use a unique identifier (e.g., a unique name or a unique number), and database functions. As one example, the information regarding the accessory device may be identify a type of feature, which is used as an input to identify the test cases. As another example, the information regarding the accessory device may be identify a category of accessory functionality, which is used as an input to identify the test cases. As another example, the information regarding the accessory device may be identify a specific type of accessory functionality, which is used as an input to identify the test cases.

Identifying test cases in operation 342 can be performed in the manner described with respect to identification of test cases from the test repository 222 by the test administrator 224 using the accessory device description 228 in the system 210.

Operation 343 includes generating a test plan that includes the test cases that were identified in operation 343. The test plan may include additional information, such as a testing order that specifies the order in which test procedures corresponding to the test cases are to be performed. Operation 343 may be performed by a server system, such as the testing server 214. The test plan may be implemented in accordance with the description of the test plan 230 of the system 210.

Operation 344 includes transmitting the test plan that was generated in operation 343 to a test device that will perform the tests that are described by the test plan. Operation 343 may be performed by a server system, such as the testing server 214, by transmitting the test plan from the testing server to the test device, such as the test device 216. Thus, receiving the test plan from the testing server may be performed by the test device (e.g., the test device 216).

Operation 345 includes performing test procedures that correspond to the test cases to determine test results (e.g., the test results 232). Operation 345 may be performed by the test device that received the test plan in operation 344. The test procedures are performed according to the test cases in order to confirm accessory functionality of an accessory device (e.g., the accessory device 218).

For example, the test procedure may include, for each of the test cases, causing the accessory device to perform an action that corresponds to the test case, observing the action performed by the accessory device, and comparing the observation of the action to a test standard that corresponds to the test case. Specific examples of test procedures will be explained in more detail with respect to other processes.

In one implementation, the observation is made manually by a user of the system and information that corresponds to the observation is manually entered (e.g., by a user), which may be performed using the testing application of the test device.

Operation 346 includes transmitting the test results (e.g., the test results 232) from the test device and receiving the test results at the server. As one example, the test results that are transmitted to the testing server may include an indication as to whether each of the test cases was passed (pass condition) or failed (fail condition), which may be judged by comparison of information observed during the test to a testing standard. As another example, test results indicating a pass condition or a fail condition are not determined by the test device. Instead, the test device transmits to the testing server 214 test results in the form of the information (e.g., measured values or other data) that was obtained during performance of the test procedures in operation 345, such as observations made of the actions performed by the accessory device for each test case. The testing server evaluates this information, for example, by comparison to a test standard, as previously discussed.

The process 340 is intended to confirm that an accessory device, such as the accessory device 218, is able to perform its intended functions (e.g., one or more types of accessory functionality) correctly. The process 340 is also intended to confirm that the accessory device responds correctly to the commands that are sent to it. During testing, the commands are sent by a test device, such as the test device 216. Ultimately, the accessory device will be used in a number of different contexts and will be controlled by devices having diverse hardware and software (e.g., operating system type and version) configurations, which is represented in the system 100 by the control device 104 in the use environment 102.

To ensure that the accessory device operates correctly in response to commands sent by devices having diverse hardware and software configurations, some or all of the test cases can be performed multiple times according to different hardware and software configurations. A specific hardware and software combination for the test device may be referred to as a test device configuration. As one example, multiple rounds of test procedures can be performed, with each round of the test procedure being performed using a different test device having a different test device configuration. As another example, multiple rounds of test procedures can be performed, with each round of the test procedure being performed by emulating a different test device configuration using emulation functions that are included in the testing application 217.

In some implementations, one or more of the test cases may be revised during testing according to the process 340. Because the test cases are maintained by the testing server, the testing server may determine that a test case has been updated, determine that the test case is included in a test plan of an accessory device for which testing is currently ongoing, and transmit the revised test case (or cases) to the test device.

In some implementations, the test plan for an accessory device may be revised during testing of the accessory device. For example, the test plan for the accessory device may be revised in response to changes to the test repository, such as addition of a test case to the test repository, deletion of a test case to the test repository, and/or a change to the relationships between specific types of device functionality and the test cases in the test repository. In response to such as change, because the test cases are maintained by the server, the server may determine that the information used to determine the test plan has changed, determine that testing using the test plan is currently ongoing, and transmit the revised test plan (e.g., including any new or revised test cases) to the test device.

One implementation of the process 340 is a method of confirming accessory functionality of an accessory device that includes obtaining an accessory device description that includes information regarding the accessory device and identifying a test case based on the accessory device description, wherein the test case is configured to evaluate an accessory functionality and includes a test standard. The method also includes performing, by a test device, a test procedure that evaluates the accessory functionality of the accessory device, wherein the test procedure causes the accessory device to perform an action that corresponds to the accessory functionality, and recording an observation regarding the action. The method also includes determining whether a test result corresponds to a pass condition or a fail condition based on a comparison of the observation to the test standard.

FIG. 4 is a flowchart that shows an example of a process 450 for performing a test procedure. The process 450 may be implemented using components that are implemented according to the description of components of the system 210. The process 450 is an implementation of operation 345 of the process 340, and may be incorporated in the process 340. The process 450 may be performed by a test device (e.g., the test device 216) using a testing application (e.g., the testing application 217).

Initially, the process 450 includes selecting a test case (e.g., from the test cases 226) that is included in the test plan (e.g., the test plan 230). A test case may be selected according to an order that is included in the test plan, randomly, by user selection, or in any other manner. Once the test case is selected, the test case is executed by the testing application to perform the test procedure that is described by the test case as will be described in the following operations of the process 450. Multiple iterations of the process 450 can be performed by select another test case for each subsequent iteration.

In operation 451, performing the test procedure according to the instructions that included in the test case causes the accessory device to perform an action that corresponds to the accessory functionality. Operation 451 may include transmitting, from the test device to the accessory device, a command that causes the accessory device to perform the action.

Operation 452 includes recording an observation regarding the action. The observation may be, as examples, a measured value, an estimated value, an observed condition or state, receipt of a communication (e.g., wired or wireless) from the accessory device to the test device, detection of a communication (e.g., wired or wireless from the accessory device to another device, an audio feature in an audio recording captured by a microphone that is associated with the test device, an image feature in an image captured by a camera that is associated with the test device, or a three-dimensional feature that is present in a three-dimensional scene representation that is captured by a three-dimensional sensor. In some implementations, the observation is made by the test device without user intervention. In some implementations, the observation is made by receiving, at the test device, an observation in the form of a manual user input regarding the action. In some implementations, the test device records the observation regarding the action in response to manual entry of information corresponding to the observation (e.g., by a user entering information using an input device that is associated with the test device).

Operation 453 includes determining whether a test result corresponds to a pass condition or a fail condition based on a comparison of the observation to the test standard. For example, a value, state, or other information that is included in the observation from operation 452 is compared to an expected value or range of values from the test standard that is included in the test case.

In some implementations, the test procedure is an audio-based test procedure, and in operation 452, recording the observation regarding the action includes obtaining an audio recording for the audio-based test procedure using a microphone that is associated with the test device. As one example, the accessory device may be configured to output an audible confirmation tone (e.g., using a speaker), and this audible confirmation tone may be recorded by the test device in the audio recording. As another example, mechanical elements that are associated with the accessory device may make a specific type of sound when they are operated, and this sound may be recorded by the test device in the audio recording. In operation 453, determining whether the test result corresponds to the pass condition or the fair condition includes analyzing the audio recording to identify an audio feature and comparing the audio feature to an expected audio feature that is described by the test standard. As one example, the expected audio feature may be described by audio characteristics, for example, requiring a tone within a specified frequency band, that is played within a particular time window, and lasts for a particular duration (e.g., falls within an acceptable range of durations according to the test standard). As another example, the audio recording may be analyzed by analysis software (e.g., implemented using a trained neural network) that identifies audio features from the audio recording and compares the identified audio features to the expected audio features.

In some implementations, the test procedure is an image-based test procedure, and in operation 452, recording the observation regarding the action includes obtaining an image for the image-based test procedure using a camera that is associated with the test device. The camera may be a still image camera or a video camera, as previously described, and is configured to output an image (e.g., still image or video frame) that is comprised of pixels in a spatial arrangement (e.g., a grid) that each have a pixel value (e.g., color and/or intensity values). The image may be taken with at least a portion of the accessory device present within a field of view of the camera so that at least part of the accessory device is represented in the image. As one example, the accessory device may be a light that has an illumination intensity and an illumination color, and the image obtained by the camera shows the illumination intensity and the illumination color. As another example, the accessory device may include moving mechanical components (e.g., a ceiling fan), and the image obtained by the camera shows the moving mechanical components. In operation 452, determining whether the test result corresponds to the pass condition or the fair condition includes analyzing the image to identify an image feature and comparing the image feature to an expected image feature that is described by the test standard. As one example, image content analysis may be used to identify whether an image feature represented by brightness value and or color value in a specific area of the recorded image is within an acceptable range as identified by the expected image feature from the test standard. As another example, image analysis software (e.g., implemented using a trained neural network) may be used to analyze the image, identify image features in the image, and compare the image features to expected image features that are described by the test standard.

In some implementations, the test procedure is a three-dimensional feature based test procedure, and in operation 452, recording the observation regarding the action includes obtaining a three-dimensional scene representation using a three-dimensional sensor that is associated with the test device. At least part of the accessory device is included in the three-dimensional scene representation. A three-dimensional feature that corresponds to performance of the action is identified in the three-dimensional representation, and is compared to an expected three-dimensional feature that corresponds to performance of the test. The expected three-dimensional feature may be, for example, a position, size, orientation, structural configuration, speed, and/or travel path of the accessory device. The expected three-dimensional feature may be described by a testing standard. As one example, the expected three-dimensional feature may be movement of a mechanical component that is associated with the accessory device at a particular time, speed, and/or spatial extent of travel.

In operations 451 and 452 an elapsed time between sending a command and performance of the action by the accessory device may be recorded and evaluated according to the test standard (e.g., an acceptable maximum elapsed time indicated in the test standard) to determine whether the result corresponds to the pass state or the fail state in operation 453. For example, a time measurement (e.g., a time stamp in absolute time or relative time) may commence when a command is sent to the accessory device, and the time measurement may stop when the observation is recorded and shows that the action has been performed by the accessory device. This time measurement is the elapsed time between sending the command and performance of the action by the accessory device.

According to instructions (e.g., computer-interpretable program instructions) that are included in the test case that was selected in operation 341, the testing application sends one or more commands to the accessory device, for example, using a local area network that is accessible to both the test device and the accessory device. The one or more commands are intended to cause the accessory device to perform an action that corresponds to one or more types of accessory functionality that are being evaluated by the test case.

Operation 345 includes performing test procedures that correspond to the test cases to determine test results (e.g., the test results 232). Operation 345 may be performed by the test device that received the test plan in operation 344. The test procedures are performed according to the test cases in order to confirm accessory functionality of an accessory device (e.g., the accessory device 218).

For example, the test procedure may include, for each of the test cases, causing the accessory device to perform an action that corresponds to the test case, observing the action performed by the accessory device, and comparing the observation of the action to a test standard that corresponds to the test case. Specific examples of test procedures will be explained in more detail with respect to other processes.

One implementation of the process 450 is a method of confirming an accessory functionality of an accessory device. The method includes receiving, by a test device from a testing server, a test case that is identified by the testing server based on the accessory functionality. The test case is configured to evaluate the accessory functionality and includes a test standard. The method also includes performing, by the test device, a test procedure that corresponds to the test case. The test procedure causes the accessory device to perform an action that corresponds to the accessory functionality. The method also includes recording an observation regarding the action, and determining whether a test result corresponds to a pass condition or a fail condition based on a comparison of the observation to the test standard.

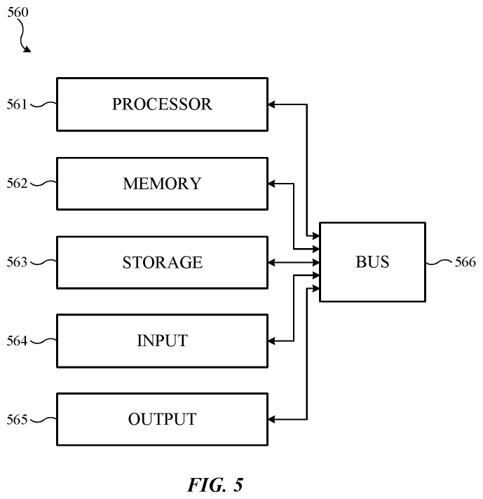

FIG. 5 is an illustration that shows an example of a hardware configuration for a computing device that can be used to implement the system described herein. The computing device 560 may include a processor 561, a memory 562, a storage device 563, one or more input devices 564, and one or more output devices 565. The computing device 560 may include a bus 566 or a similar device to interconnect the components for communication. The processor 561 is operable to execute computer program instructions and perform operations described by the computer program instructions. As an example, the processor 561 may be a conventional device such as a central processing unit. The memory 562 may be a volatile, high-speed, short-term information storage device such as a random-access memory module. The storage device 563 may be a non-volatile information storage device such as a hard drive or a solid-state drive. The input devices 564 may include any type of human-machine interface such as buttons, switches, a keyboard, a mouse, a touchscreen input device, a gestural input device, an audio input device such as a microphone that is configured to output an audio signal that can be stored as an audio recording, and an image input device such as a still image camera that is able to define a raster image (e.g., comprised of pixels) that represents a scene or a video camera that is operable to define raster video frames that represent a scene. The output devices 565 may include any type of device operable to provide an indication to a user regarding an operating state, such as a display screen or an audio output.

As described above, one aspect of the present technology is the gathering and use of data available from various sources for use in testing accessory functionality and for use in controlling accessory functionality. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to store user preferences regarding accessory devices that are located in the user's home. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, systems that use the present technology can be configured to allow users to select to “opt in” or “opt out” of participation in the collection of personal information data during registration for services or anytime thereafter. In another example, users can select not to provide personal information to services that use the present technology. In yet another example, users can select to limit the length of time personal information is maintained by services that use the present technology, or users may entirely prohibit use of personal information by systems that use the present technology. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, accessory devices may be configured and used based on non-personal information data or a bare minimum amount of personal information, other non-personal information available to the services that are using the present technology, or publicly available information.

What is claimed is:

1. A method of confirming an accessory functionality of an accessory device, comprising:
obtaining an accessory device description that includes information regarding the accessory device;
identifying a test case based on the accessory device description, wherein the test case is configured to evaluate the accessory functionality and includes a test standard;
performing, by a test device, a test procedure that corresponds to the test case, wherein the test procedure causes the accessory device to perform an action that corresponds to the accessory functionality;
recording an observation regarding the action; and
determining whether a test result corresponds to a pass condition or a fail condition based on a comparison of the observation to the test standard.

2. The method of claim 1, wherein the information regarding the accessory device identifies the accessory functionality.

3. The method of claim 1, wherein the information regarding the accessory device identifies a feature of the accessory device, and the feature is associated with the accessory functionality.

4. The method of claim 1, wherein performing the test procedure includes transmitting, from the test device to the accessory device, a command that causes the accessory device to perform the action.

5. The method of claim 1, wherein recording the observation regarding the action is performed in response to manual entry of information corresponding to the observation.

6. The method of claim 1, wherein the test procedure is an audio-based test procedure, recording the observation regarding the action includes obtaining an audio recording for the audio-based test procedure using a microphone that is associated with the test device, and determining whether the test result corresponds to the pass condition or the fail condition includes analyzing the audio recording to identify an audio feature and comparing the audio feature to an expected audio feature that is described by the test standard.

7. The method of claim 1, wherein the test procedure is an image-based test procedure, recording the observation regarding the action includes obtaining an image for the image-based test procedure using a camera that is associated with the test device, and determining whether the test result corresponds to the pass condition or the fail condition includes analyzing the image to identify an image feature and comparing the image feature to an expected image feature that is described by the test standard.

8. The method of claim 1, wherein the test procedure is a three-dimensional feature based test procedure, recording the observation regarding the action includes a three-dimensional scene representation using a three-dimensional sensor that is associated with the test device, and determining whether the test result corresponds to the pass condition or the fail condition includes analyzing the image to identify three-dimensional feature and comparing the three-dimensional feature to an expected three-dimensional feature that is described by the test standard.

9. A method of confirming an accessory functionality of an accessory device, comprising:
receiving, by a test device from a testing server, a test case that is identified by the testing server based on the accessory functionality, wherein the test case is configured to evaluate the accessory functionality and includes a test standard;
performing, by the test device, a test procedure that corresponds to the test case, wherein the test procedure causes the accessory device to perform an action that corresponds to the accessory functionality;
recording an observation regarding the action; and
determining whether a test result corresponds to a pass condition or a fail condition based on a comparison of the observation to the test standard.

10. The method of claim 9, wherein performing the test procedure includes transmitting, from the test device to the accessory device, a command that causes the accessory device to perform the action.

11. The method of claim 9, wherein the test device records the observation regarding the action in response to manual entry of information corresponding to the observation.

12. The method of claim 9, wherein the test procedure is an audio-based test procedure, recording the observation regarding the action includes obtaining an audio recording for the audio-based test procedure using a microphone that is associated with the test device, and determining whether the test result corresponds to the pass condition or the fail condition includes analyzing the audio recording to identify an audio feature and comparing the audio feature to an expected audio feature that is described by the test standard.

13. The method of claim 9, wherein the test procedure is an image-based test procedure, recording the observation regarding the action includes obtaining an image for the image-based test procedure using a camera that is associated with the test device, and determining whether the test result corresponds to the pass condition or the fail condition includes analyzing the image to identify an image feature and comparing the image feature to an image audio feature that is described by the test standard.

14. The method of claim 9, wherein the test procedure is a three-dimensional feature based test procedure, recording the observation regarding the action includes a three-dimensional scene representation using a three-dimensional sensor that is associated with the test device, and determining whether the test result corresponds to the pass condition or the fail condition includes analyzing the image to identify three-dimensional feature and comparing the three-dimensional feature to an expected three-dimensional feature that is described by the test standard.

15. A non-transitory computer-readable storage device including program instructions executable by one or more processors that, when executed, cause the one or more processors to perform operations, the operations comprising:
receiving, by a test device from a testing server, a test case that is identified by the testing server based on an accessory functionality of an accessory device, wherein the test case is configured to evaluate the accessory functionality and includes a test standard;
performing, by the test device, a test procedure that corresponds to the test case, wherein the test procedure causes the accessory device to perform an action that corresponds to the accessory functionality;
recording an observation regarding the action; and
determining whether a test result corresponds to a pass condition or a fail condition based on a comparison of the observation to the test standard.

16. The non-transitory computer-readable storage device of claim 15, wherein performing the test procedure includes transmitting, from the test device to the accessory device, a command that causes the accessory device to perform the action.

17. The non-transitory computer-readable storage device of claim 15, wherein the test device records the observation regarding the action in response to manual entry of information corresponding to the observation.

18. The non-transitory computer-readable storage device of claim 15, wherein the test procedure is an audio-based test procedure, recording the observation regarding the action includes obtaining an audio recording for the audio-based test procedure using a microphone that is associated with the test device, and determining whether the test result corresponds to the pass condition or the fail condition includes analyzing the audio recording to identify an audio feature and comparing the audio feature to an expected audio feature that is described by the test standard.

19. The non-transitory computer-readable storage device of claim 15, wherein the test procedure is an image-based test procedure, recording the observation regarding the action includes obtaining an image for the image-based test procedure using a camera that is associated with the test device, and determining whether the test result corresponds to the pass condition or the fail condition includes analyzing the image to identify an image feature and comparing the image feature to an image audio feature that is described by the test standard.

20. The non-transitory computer-readable storage device of claim 15, wherein the test procedure is a three-dimensional feature based test procedure, recording the observation regarding the action includes a three-dimensional scene representation using a three-dimensional sensor that is associated with the test device, and determining whether the test result corresponds to the pass condition or the fail condition includes analyzing the image to identify three-dimensional feature and comparing the three-dimensional feature to an expected three-dimensional feature that is described by the test standard.

21. A system, comprising:
a memory; and
one or more processors that are configured to execute instructions that are stored in the memory, wherein the instructions, when executed by the one or more processors, cause the one or more processors to:
receive, from a testing server, a test case that is identified by the testing server based on an accessory functionality of an accessory device, wherein the test case is configured to evaluate the accessory functionality and includes a test standard,
perform a test procedure that corresponds to the test case, wherein the test procedure causes the accessory device to perform an action that corresponds to the accessory functionality,
record an observation regarding the action, and
determine whether a test result corresponds to a pass condition or a fail condition based on a comparison of the observation to the test standard.

22. The system of claim 21, wherein performing the test procedure includes transmitting, to the accessory device, a command that causes the accessory device to perform the action.

23. The system of claim 21, wherein the instructions further cause the one or more processors to record the observation regarding the action in response to manual entry of information corresponding to the observation.

24. The system of claim 21, wherein the test procedure is an audio-based test procedure, the instructions further cause the one or more processors to record the observation regarding the action by obtaining an audio recording for the audio-based test procedure using a microphone, and determining whether the test result corresponds to the pass condition or the fail condition includes analyzing the audio recording to identify an audio feature and comparing the audio feature to an expected audio feature that is described by the test standard.

25. The system of claim 21, wherein the test procedure is an image-based test procedure, recording the observation regarding the action includes obtaining an image for the image-based test procedure using a camera, and determining whether the test result corresponds to the pass condition or the fail condition includes analyzing the image to identify an image feature and comparing the image feature to an image audio feature that is described by the test standard.

26. The system of claim 21, wherein the test procedure is a three-dimensional feature based test procedure, recording the observation regarding the action includes a three-dimensional scene representation using a three-dimensional sensor that is associated with the test device, and determining whether the test result corresponds to the pass condition or the fail condition includes analyzing the image to identify three-dimensional feature and comparing the three-dimensional feature to an expected three-dimensional feature that is described by the test standard.
